(19) United States
(12) Patent Application Publication
(10) Pub. No.: US 2021/0148475 A1
(43) Pub. Date: May 20, 2021

(54) Non-Return Device Suitable for Crude Gas Lines of Filtering Separators

(71) Applicant: REMBE GmbH Safety + Control, Brilon (DE)

(72) Inventors: Stefan PENNO, Brilon (DE); Roland BUNSE, Brilon (DE)

(21) Appl. No.: 16/886,199

(22) Filed: May 28, 2020

(30) Foreign Application Priority Data
Mar. 29, 2019 (EP) 19166247.7

(51) Int. Cl. F16K 15/03

(52) U.S. Cl. CPC F16K 15/03

(57) ABSTRACT

A non-return device, for example, for a crude gas line, comprises a housing, a seat, arranged in the housing, and a flap that is pivotably attached in the housing and rests on the seat in a closed state of the non-return device and is lifted off of the seat in an open state of the non-return device. The flap comprises at least one flexible connecting element on the housing, with a first end region of the connecting element being attached to the housing and with a second end region of the connecting element being attached to the flap.

### CROSS REFERENCE TO RELATED APPLICATIONS

This application claims foreign priority under 35 U.S.C. § 119(a)-(d) to Application No. EP 19166247.7 filed on Mar. 29, 2019, the entire contents of which are hereby incorporated by reference.

### TECHNICAL FIELD

The present invention relates to a non-return device, for example, for a crude gas line of filtering separators, the non-return device comprising: a housing, a seat arranged in the housing, and a flap that is pivotably attached in a housing and rests on the seat in a closed state of the non-return device and is lifted off of the seat in an open state of the non-return device.

### BACKGROUND

The applicant offers a non-return device with a flap under the name “Q flap RX.” The non-return device lends itself to being installed on the suction side of the equipment in a pipeline. In the event of an explosion in the equipment, where the explosion will propagate through the pipeline, the non-return device is suitable for closing the crude gas line in order to decouple those parts of the plant that are arranged on the inlet side of the non-return device from the equipment and, in so doing, to protect such equipment against an explosion that would otherwise propagate through the pipeline.

The flap of known non-return devices is usually connected to the housing by hinges or swivel bearings. Sometimes, the non-return devices have to be serviced or inspected.

For an effective decoupling it is necessary for the flap, which is arranged so as to be capable of pivoting in the housing of the non-return device, to pivot into its closed position in the event of an explosion. It is also very important for the flap to make good contact with the seat in the closed state.

Both objectives can be achieved by carefully adjusting the flap during assembly in the housing. After some time of usage the adjustments should be checked and, if required, changed. In order to be able to do so, but also to service the hinges or swivel bearings, it is necessary to remove the non-return device from the pipeline, since otherwise it is not possible to reach the elements, provided for the adjustment, or, more specifically, the hinges or swivel bearings.

The removal of the non-return device from the pipeline has turned out to be complicated.

### SUMMARY

The invention is based on the problem of improving a non-return device and the pivotable connection between the flap and the housing such that it is easier to service and adjust.

This problem is solved by the present invention in that the flap has at least one flexible connecting element on the housing, with a first end region of the connecting element being attached to the housing and with a second end region of the connecting element being attached to the flap.

A hinge or a swivel bearing, as it is known from the non-return devices of the prior art, is not provided in the non-return device of the present invention. Instead, the flexible connecting element is used that allows the flap to move with respect to the housing. The flexible connecting element requires no maintenance.

In the case of the non-return device of the present invention the length of a section of the connecting element between the housing and the flap can be adjustable. Such an adjustment is possible preferably from outside of the housing. In this way, the position of the connection between the connecting element and the flap relative to the housing can be fixed from outside of the housing. Opening the housing or removal of the housing from the pipeline is not necessary for this purpose.

The connecting element of a non-return device of the present invention may have an external thread on the first end region.

The first end region may extend through a through bore of the housing. For this purpose, the first end region can be routed in another sleeve that is attached in the through bore.

A nut can be screwed on that section of the first end region that projects from the housing. By rotating the nut, the length of the section of the connecting element between the housing and the flap can be adjusted.

A non-return device of the present invention may have a support element on which the connecting element can be supported at least in the closed state of the non-return device. A position of a support location at which the connecting element is supported on the support element can be adjustable. The support element may have a region with an external thread. The region of the support element with the external thread may extend through a through bore of the housing. Then a nut may be screwed on that section of the region of the support element that projects from the housing and that has the external thread. By rotating the nut, the position of the support location at which the connecting element (4) is supported on the support element can be adjusted.

The support element may be a bolt that is bent in a U-shaped manner, with the end regions of the bolt having an external thread and with the connecting element being supported on the central region of the bolt.

The housing may be a conical section on the inlet side, with the diameter of the conical section becoming larger from the inlet to the center of the housing.

A socket, which begins at the inlet, projects into the conical section, with the free end of the socket forming the seat of the non-return device.

The through bore for the support element and the connecting element are provided in the conical section of the housing.

The non-return device may have two connecting elements and two support elements.

### BRIEF DESCRIPTION OF THE DRAWINGS

Other features and advantages of the present invention will become apparent from the following description of a preferred exemplary embodiment with reference to the accompanying drawings.

FIG. 1 is a side view of a non-return device of the present invention;

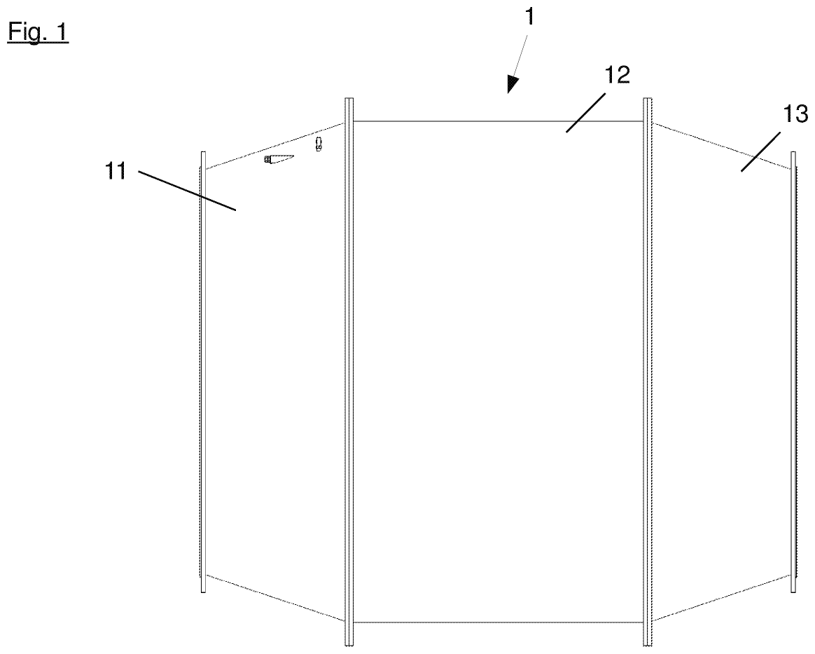

FIG. 2 is a plan view of the non-return device;

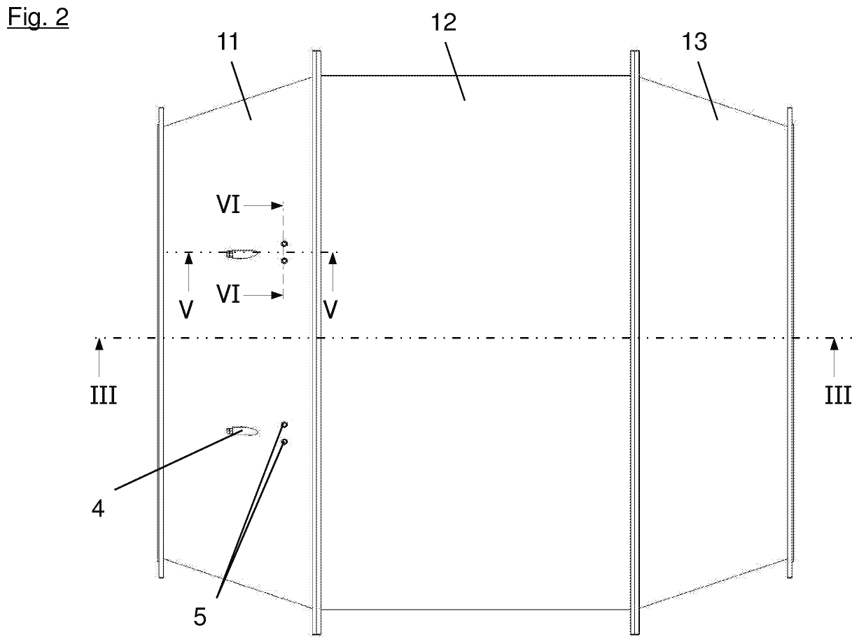

FIG. 3 is a longitudinal section through the non-return device along the line in FIG. 2;

FIG. 4 is an enlarged cutout from FIG. 3;

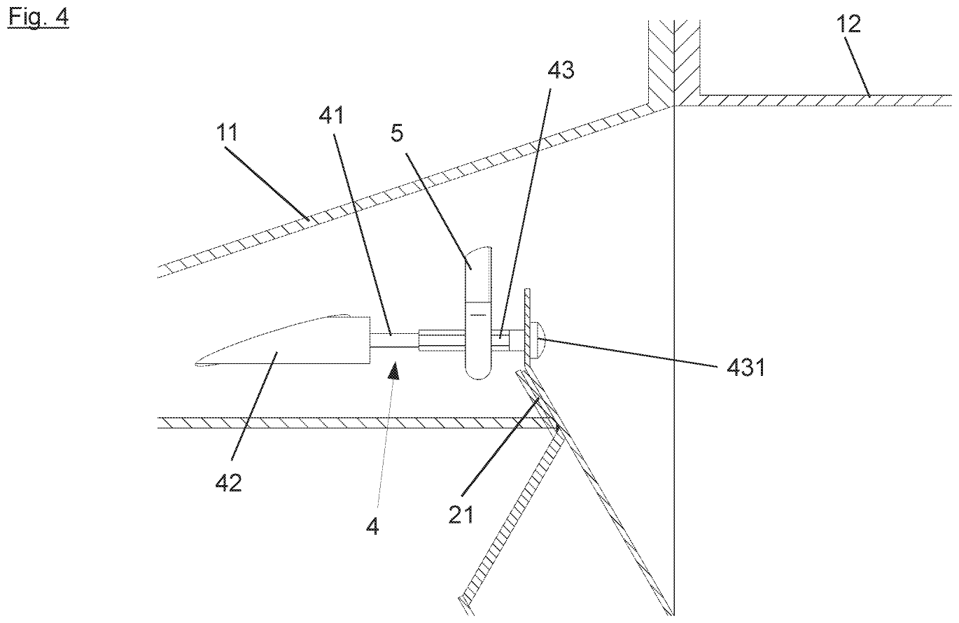

FIG. 5 is a section along the line V-V in FIG. 3; and

FIG. 6 is a section along the line VI-VI in FIG. 3.

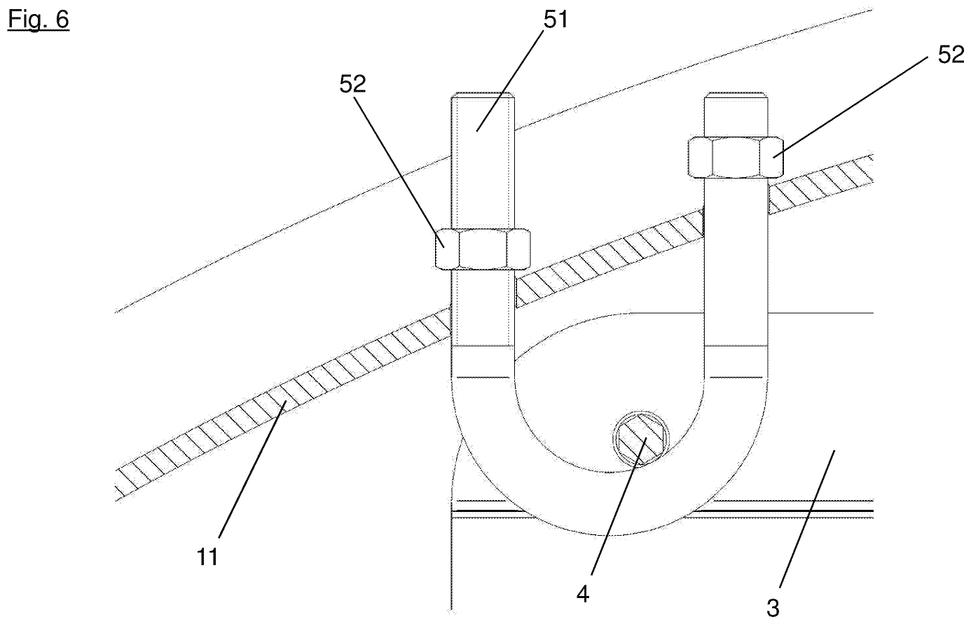

### DETAILED DESCRIPTION

The inventive non-return device, depicted in the figures, comprises a housing 1 that has a shape like a barrel. The housing has an inlet-sided, conical section 11 (more specifically, having a frustoconical shape), a circularly cylindrical central section 12 and an outlet-sided, conical section 13 (more specifically, having a frustoconical shape).

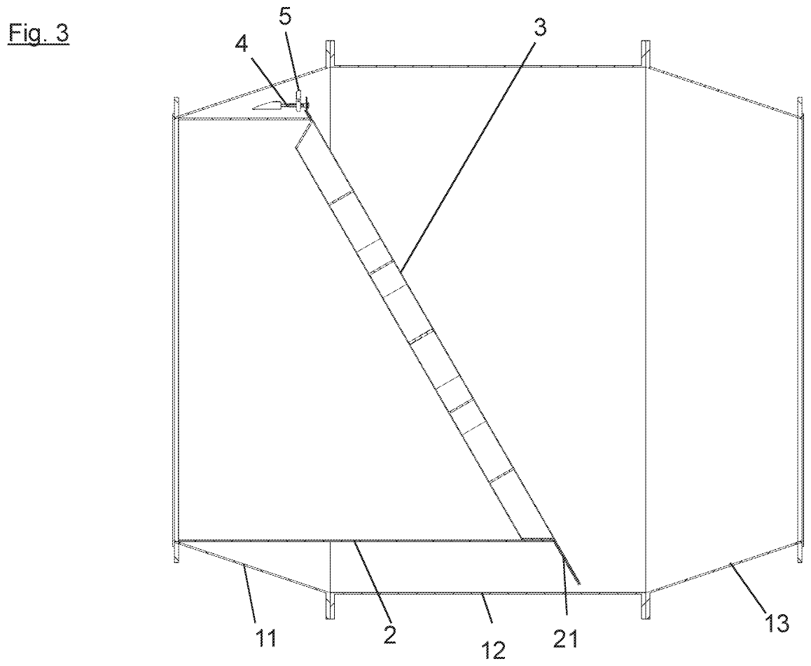

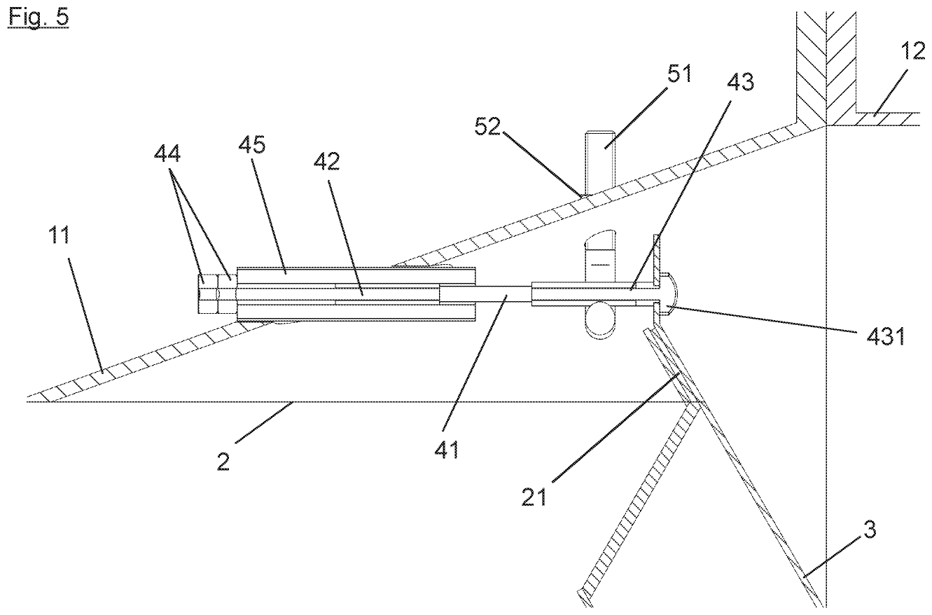

Connected to the inlet of the housing, a socket 2 projects into the housing 1, as shown in FIGS. 3 and 5. The socket is cut off at an angle on the outlet side. This angularly cut end of the socket forms a seat 21 of the non-return device, against which seat a flap 3 of the non-return device abuts in the closed state of the non-return device, in which state the non-return device is shown in the figures.

The flap 3 is connected to the housing 1 by two flexible connecting elements 4. Each of the connecting elements 4 has a central flexible section, which is formed by a steel cable 41, but alternatively could be made of a different, suitably flexible material or flexible parts.

One of the connecting elements 4 is described in greater detail below. The other of the two connecting elements is designed in the same way.

The ends of the steel cable 41 are held in the sleeves 42, 43.

The sleeve 42 on a first end has an external thread. This external thread is passed through an additional sleeve 45 that is inserted into a recess in the inlet-sided, conical section 11 of the housing 1. The external thread can be displaced in the additional sleeve 45. Two nuts 44 are screwed on the external thread from outside of the housing 1, with one of the two nuts 44 being a lock nut.

The sleeve 43 on a second end of the steel cable 41 has a mushroom head 431. The second sleeve 43 is passed through a recess in the flap 3 and, in particular, such that the mushroom head 431 is arranged on the outlet side of the flap, while the other connecting element 4 is arranged on the inlet side of the flap.

The distance between the nuts 44 and the mushroom head 431 can be adjusted by adjusting the nut 44. At the same time this feature makes it possible to adjust the length of a section of the connecting element 4 between the housing 1 and the flap 3. In this way, an adjustment of the flap 3 from outside of the housing 1 is possible; in particular, it is possible to adjust the position that the flap has in the direction from the inlet to the outlet of the non-return device.

Each of the two connecting elements 4 is supported with its section, located between the housing 1 and the flap 3, on one support element 5 each.

One of the support elements 5 is described in more detail below. The other of the two support elements 5 is designed in the same way.

The support element 5 has a bolt 51 that is bent in a U-shaped manner and that has an external thread on each of its ends. These ends are passed through recesses in the inlet-sided, conical section 11 of the housing 1. Nuts 52 are screwed on the ends from the outside, so that the nuts can be used to adjust the extent to which the bolt 51 projects into the housing 1. This aspect makes it possible to adjust the support location, at which the connecting element 4 is supported on the bolt 5, from outside of the housing. At the same time this aspect can be used to adjust, in particular, the position and orientation of the flap 3 perpendicular to the direction of the inlet to the outlet of the non-return device.

What is claimed is:

1. A non-return device for a crude gas line, comprising:
a housing;
a seat arranged in the housing;
a flap pivotably attached in the housing, the flap resting on the seat in a closed state of the non-return device and being lifted off of the seat in an open state of the non-return device; and
at least one flexible connecting element having a first end region attached to the housing and a second end region attached to the flap.

2. The non-return device of claim 1, wherein a length of a section of the at least one flexible connecting element between the housing and the flap is adjustable.

3. The non-return device of claim 2, wherein the at least one flexible connecting element comprises an external thread on the first end region.

4. The non-return device of claim 3, wherein the first end region of the at least one flexible connecting element extends through a through bore of the housing, the non-return device further comprising a nut screwed onto a section of the first end region that projects from the housing.

5. The non-return device of claim 4, wherein, the length of the section of the at least one flexible connecting element between the housing and the flap is adjustable by rotating the nut.

6. The non-return device of claim 1, further comprising a support element on which the at least one flexible connecting element is supported at least in the closed state of the non-return device.

7. The non-return device of claim 6, wherein a position of a support location at which the at least one flexible connecting element is supported on the support element is adjustable.

8. The non-return device of claim 6, wherein the support element comprises a region with an external thread.

9. The non-return device of claim 8, wherein the region of the support element with the external thread extends through a through bore of the housing, the non-return device further comprising a nut screwed on a section of the region of the support element that projects from the housing and that has the external thread.

10. The non-return device of claim 9, wherein the position of the support location at which the at least one flexible connecting element is supported on the support element is adjustable by rotating the nut.

11. The non-return device of claim 6, wherein the support element is a bolt bent in a U-shaped manner and end regions of which have external threads, the at least one flexible connecting element being supported on a central region of the bolt.

12. The non-return device of claim 6, wherein the at least one flexible connecting element comprises two flexible connecting elements and two corresponding support elements.

13. The non-return device of claim 1, wherein the housing has on an inlet side a conical section, the diameter of which becomes larger from the inlet to a center of the housing.

14. The non-return device of claim 13, further comprising a socket that projects from the inlet into the conical section, a free end of the socket forming the seat.

15. The non-return device of claim 13, wherein through bores are provided in the conical section of the housing.
